(19) United States
(12) Patent Application Publication
(10) Pub. No.: US 2008/0026176 A1
(43) Pub. Date: Jan. 31, 2008

(54) Method for Stabilising a Pile Fabric Such as a Pile Carpet with a Reinforcing Backing and a Sheet Cloth Produced by Said Method

(76) Inventor: Manfred Aulbach, Momlingen (DE)

Correspondence Address: K.F. ROSS P.C., 5683 RIVERDALE AVENUE, SUITE 203 BOX 900, BRONX, NY, 10471-0900, US

(21) Appl. No.: 10/577,572

(22) PCT Filed: Nov. 9, 2004
(86) PCT No.: PCT/EP04/52895

§ 371 Date: Apr. 27, 2006

(30) Foreign Application Priority Data
Nov. 13, 2003 (DE) 103 53 187.4

(51) Int. Cl. D04H 11/00; B32B 5/26; D06N 7/00

(52) U.S. Cl. 428/95; 156/72

(57) ABSTRACT

In the case of pile carpeting, e.g. whose pile fibres are tufted in a support layer, it is known to provide the backing of the support layer with a nonwoven and bond this to the support layer and the backing fibres of the pile fibres by means of hydrodynamic needle-punching. It is furthermore known to apply an intermediate layer to the support layer between support layer and nonwoven comprising at least partly fusible fibres and to bond the two by means of hydrodynamic needle punching to the carpet backing. The invention proposes that the intermediate layer is formed of a hot melt powder, short-staple fusible fibres or a fusible film and these should initially be moved into the backing of the support layer by hydrodynamic needling before the melting process effects the actual fixing of the pile fibres in the support layer.

Known from EP-A-1 081 263 is a method for continuous stabilisation of pile carpeting, tufted carpeting, plush carpeting and the like, in any case of web-like goods with a visible side whose structure and quality must not be modified and a backing support layer in which the pile-forming yarns are incorporated and must be anchored there since the pile yarns have merely been unstably incorporated, e.g. tufted in the support layer made, for example, of a spunbonded nonwoven, a woven fabric or knitted fabric, in any case for anchoring the pile yarns held only loosely in the support layer by means of hydrodynamic water needle-punching in the support layer.

This method is of particular importance for the recyclability of a carpet. In future, the conventionally used latex foam backing will no longer be necessary for stabilising the pile fibres.

Before this development it was known to spread the backing of a carpet, the back of the support layer with the pile fibres affixed therein, with a hot melt powder (EP-A-0 005 050). However, this method was not successful since mixing of the powder with the support layer could not be sufficiently produced. The same applies if a fusible fibre (DE-A-195 06 845) or a fusible film (DE-A-43 41 168) is applied instead of a powder. Intensive joining of the backing fibres to the support layer could not be achieved by these methods. No pressing process was of assistance here merely because the pile fibres cannot be exposed to too-high pressure.

It was further known from DE-A-42 44 172 to join the textile secondary backing, say the nonwoven, to the support layer via an intermediate nonwoven. This intermediate nonwoven should at least partially consist of thermoplastic fibres which should then produce a better bonding of the pile fibres in the support layer as a result of melting. However, the disadvantage specified above still applies. A further development is disclosed in DE-A-100 56 180 whereby the secondary backing together with the intermediate layer should be bonded to the support layer by means of hydrodynamic needle punching.

None of these methods yielded the desired result merely because no sufficient mixing of the components of the bonding layer such as the intermediate layer with, for example, the tufted backing components of the pile fibres and the fibres of the support layer could be achieved.

Starting from the method according to EP-A-1 081 263, it is the object of the invention to achieve a further improvement in the incorporation of the pile fibres in the support layer by a supplementary method.

This object is solved by a method for continuous stabilisation of pile carpeting, tufted carpeting or plush carpeting, in any case of web-like goods with a visible side whose structure and quality must not be modified and a backing support layer in which the pile-forming yarns are incorporated and are anchored there by means of hydrodynamic water needling wherein a hot melt powder, short-staple fusible fibres or a hot melt film are applied as an intermediate layer to the back of the support layer provided with pile fibres, a nonwoven is placed thereover and the back of the support layer is then subjected twice to hydrodynamic needle-punching, once for intensive bonding of the intermediate layer to the backing fibres of the pile and the support layer and secondly for bonding the nonwoven to the support layer to produce the carpet backing, and then the carpet is subjected to heat treatment to melt the powder, the fusible fibres or the film.

It is especially advantageous if, after the first hydrodynamic needle-punching the carpet is heat-treated to melt the intermediate layer and subjected to further hydrodynamic needling after application of the nonwoven.

The method according to the invention produces web goods consisting of a support layer into which pile-forming yarns are inserted and anchored therein by means of hydrodynamic water needle-punching, wherein an intermediate layer of molten powder, molten chemical fibres or a molten film is provided on the back of the support layer provided with pile fibres, and a nonwoven is placed thereover and the backing of the support layer has been subjected twice to hydrodynamic needle-punching, once for intensive bonding of the intermediate layer to the backing fibres of the pile and the support layer and secondly for bonding the nonwoven to the support layer to produce the carpet backing, and then the carpet has been treated with heat to melt the powder, the fusible fibres or the film.

1. A method for continuous stabilisation of pile carpeting, tufted carpeting or plush carpeting, in any case of web-like goods with a visible side whose structure and quality must not be modified and a backing support layer in which the pile-forming yarns are incorporated and are anchored there by means of hydrodynamic water needle-punching, characterised in that a hot melt powder, short-staple fusible fibres or a hot melt film are applied as an intermediate layer to the back of the support layer provided with pile fibres, a nonwoven is placed thereover and the back of the support layer is then subjected twice to hydrodynamic needle-punching, once for intensive bonding of the intermediate layer to the backing fibres of the pile and the support layer and secondly for bonding the nonwoven to the support layer to produce the carpet backing, and then the carpet is subjected to heat treatment to melt the powder, the fusible fibres or the film.

2. The method according to claim 1, characterised in that after the first hydrodynamic needle-punching the carpet is heat-treated to melt the intermediate layer and subjected to further hydrodynamic needling after application of the nonwoven.

3. Web goods consisting of a support layer into which pile-forming yarns are inserted and anchored therein by means of hydrodynamic water needle-punching, characterised in that an intermediate layer of molten powder, molten chemical fibres or a molten film is provided on the back of the support layer provided with pile fibres, and a nonwoven is placed thereover and the backing of the support layer has been subjected twice to hydrodynamic needle-punching, once for intensive bonding of the intermediate layer to the backing fibres of the pile and the support layer and secondly for bonding the nonwoven to the support layer to produce the carpet backing, and then the carpet has been treated with heat to melt the powder, the fusible fibres or the film.
